(19) United States
(12) Patent Application Publication
(10) Pub. No.: US 2017/0098250 A1
(43) Pub. Date: Apr. 6, 2017

(54) ACCOUNTING FOR DIFFERENCES IN USER INTERACTION WITH CONTENT PRESENTED BY DIFFERENT SYSTEMS WHEN SELECTING CONTENT BY AN ONLINE SYSTEM

(71) Applicant: Facebook, Inc., Menlo Park, CA (US)

(72) Inventors: Robert Daniel Paul Masson, Seattle, WA (US); Glen Thomas Hastings, La Verne, CA (US); Lisa Marie Erickson, Newark, CA (US)

(21) Appl. No.: 14/983,106

(22) Filed: Dec. 29, 2015

Related U.S. Application Data
(60) Provisional application No. 62/236,109, filed on Oct. 1, 2015.

(51) Int. Cl. G06Q 30/02

(52) U.S. Cl. CPC G06Q 30/0275

(57) ABSTRACT

An online system presents advertisements itself and provides advertisements to third party systems. To mitigate different amounts interactions performed by users presented with advertisements via the online system or presented via a third party system, the online system modifies bid amounts associated with advertisements based on a difference in a number of interactions performed by users presented with advertisements via the online system and a number of interactions performed by users presented with advertisements via a third party system. Based on the difference in interactions performed by users presented with advertisements via the online system and via the third party system, the online system modifies bid amounts associated with advertisements. When the third party system requests an advertisement from the online system, the online system selects an advertisement for the third party system using the modified bid amounts.

### CROSS REFERENCE TO RELATED APPLICATIONS

This application claims the benefit of U.S. Provisional Application No. 62/236,109, filed Oct. 1, 2015, which is hereby incorporated by reference in its entirety.

### BACKGROUND

This invention relates generally to selecting content for presentation to users, and more specifically to determining amounts of compensation when presenting sponsored content using different systems.

Various online systems provide content to client devices for presentation to online system users via one or more networks. An online system may select content for presentation to a user based on information about the user maintained by the online system. For example, an online system allows a user to establish connections between other users and to provide content to the online system, which provides the content to the other users connected to the user. The increasing popularity of online systems, and the significant amount of user-specific information maintained by online systems, allow users of an online system allows to easily communicate information about themselves to other users and share content with other users.

Additionally, entities may sponsor presentation of content items via an online system to gain public attention for the entity's products or services, or to persuade online system users to take an action regarding the entity's products or services. Many online systems receive compensation from an entity for presenting online system users with certain types of sponsored content items provided by the entity. Frequently, online systems charge an entity for each presentation of sponsored content to an online system user (e.g., each “impression” of the sponsored content) or for each interaction with sponsored content by an online system user (e.g., each “conversion”). For example, an online system receives compensation from an entity each time a content item provided by the entity is displayed to a user on the online system or each time a user is presented with a content item on the online system and the user interacts with the content item (e.g., requests additional content by interacting with the content item).

An online system may select content for presentation to users via the online system itself or for presentation by a third party system other than the online system. When selecting certain content, an online system may account for an amount of compensation received by the online system from an entity associated with content in exchange for presentation of the content. However, conventional online systems receive the same amount compensation from an entity associated with content when the online system itself presents the content or when the online system communicates the content to a third party system for presentation. However, presenting content via the online system or via a third party system often results in different amounts of interaction with the content. For example, users more frequently interact with content presented via the online system than with content presented via a third party system. This discrepancy in interaction with content presented by the online system or by a third party system may reduce the benefit to an entity from having the online system provide the entity's content for presentation, which may deter the entity from providing additional content to the online system for presentation, reducing potential revenue to the online system.

### SUMMARY

An online system maintains multiple advertisement requests (“ad requests”), with each ad request including an advertisement for presentation to users and a bid amount specifying an amount of compensation received by the online system from an entity associated with the ad request in exchange for presenting the advertisement in the ad request to one or more users. The online system presents advertisements from ad requests to users via the online system and also receives requests from third party systems for advertisements to be presented by the third party system. When the online system receives a request from a third party system for an advertisement, the online system selects an advertisement from the ad requests maintained by the online system and communicates the selected advertisement to the third party system for presentation by the third party system.

However, advertisements presented to users via the online system may provide a different value to advertisers or other entities than advertisements presented to users via third party systems. For example, users more frequently interact with advertisements presented via the online system than with advertisements presented by a third party system, or more frequently perform certain types of interactions when presented with advertisements via the online system than when presented with advertisements via a third party system. Because the online system receives compensation from an entity associated with an advertisement (e.g., an advertiser) when the online system provides the advertisement for presentation by the online system or by a third party system, the entity provides the online system with compensation based on a bid amount associated with the advertisement regardless of whether the advertisement is presented by the online system or by the third party system. Differences in interactions performed by users when presented with an advertisement via the online system or via the third party system may reduce the benefit obtained by the entity from compensating the online system for providing the advertisement for presentation, which may reduce a likelihood of the entity providing additional advertisements to the online system for presentation, reducing the potential revenue to the online system from presenting advertisements.

To mitigate potential discrepancies in interactions performed by users presented with advertisements via the online system or via a third party system, the online system modifies bid amounts of ad requests including advertisements based on differences in interactions performed by users presented with advertisements via the online system and performed by users presented with advertisements via a third party system. The online system maintains information describing interactions performed by users presented with advertisements selected by the online system via the online system, so the online system identifies interactions performed by users presented with advertisements from the maintained information. For example, the online system maintains information identifying certain interactions performed by users after presentation of an advertisement via the online system (e.g., installation of an application associated with an advertisement presented by the online system, purchase of products or services within an application by users after presentation of an advertisement associated with the application to the users, purchases of goods or services by users after presentation of an advertisement associated with the goods or services by the online system, accesses of content after presentation of an advertisement associated with the content to the users by the online system, selection of an advertisement presented by the online system, etc.). Additionally, the online system obtains information from various third party systems describing interactions performed by users after the third party systems presented the users with one or more advertisements received from the online system. For example, the online system retrieves the information describing user interactions after presentation of one or more advertisements from a third party system or stores information received from the third party system describing user interactions in association with an identifier of the third party system. Based on the maintained information describing interactions performed by users after presentation of advertisements via the online system and the obtained information describing interactions performed by users after presentation of advertisements via third party systems, the online system modifies bid amounts included in various ad requests so entities associated with the ad requests receive a more uniform benefit relative to an amount provided to the online system for advertisements presented by the online system or presented by third party systems.

The online system identifies a third party system and selects a set of advertisements presented to users via the online system and also presented to users via the identified third party system. In some embodiments, the online system selects the set of advertisements so the set includes advertisements having one or more common characteristics that were presented to users by the online system and presented to users by the identified third party system. Characteristics of an advertisement include: an entity associated with the advertisement (e.g., an advertiser), an objective included in an ad request including the advertisement (i.e., a desired interaction by a user after presentation of the advertisement specified by an entity associated with the ad request), a location in which the advertisement was presented relative to other content, or any other suitable information).

Based on the information maintained by the online system describing interactions performed by users after presentation of one or more advertisements in the selected set to the users by the online system and based on the information obtained by the online system describing interactions performed by users after presentation of one or more advertisements in the selected set to the users by the identified third party system, the online system determines a metric for the identified third party system. The online system compares interactions performed by users after presentation of one or more advertisements in the selected set of advertisements to the users via the online system to interactions performed by the users after presentation of one or more advertisements in the selected set to the users via the identified third party system and determines the metric based on the comparison. For example, the online system determines the metric based on a difference between a number of a certain type of interaction performed by users after the users were presented with advertisements from the selected set via the online system and a number of the certain type of interaction performed by users after the users were presented with advertisements from the selected set via the identified third party system. As an example, the online system determines the metric based on a difference between a number of installations of applications associated with advertisements in the selected set by users after presentation of advertisements in the selected set by the online system and a number of installations of applications associated with advertisements in the selected set by users after presentation of advertisements in the selected set by the identified third party system. In some embodiments, the metric for the identified third party system is a ratio of the difference between the number of the certain type of interaction performed by users after the users were presented with advertisements from the selected set via the online system and the number of the certain type of interaction performed by users after the users were presented with advertisements from the selected set via the identified third party system to the number of the certain type of interaction performed by users after the users were presented with advertisements form the set via the online system.

The online system modifies bid amounts for various ad requests maintained by the online system based on the determined metric for the identified third party system and stores the determined metric in association with the identified third party system. In some embodiments, the online system stores the modified bid amounts in association with the identified third party system. In some embodiments, the online system associates different adjustment values with different ranges of the metric and selects an adjustment value associated with a range that includes the determined metric for the identified third party system; the online system increases or decreases the bid amount of an ad request by the selected adjustment value to modify the bid amount for the ad request. Alternatively, the online system increases or decreases a bid amount of an ad request by a percentage (or an amount) generated from the determined metric or by the determined metric. When modifying bid amounts, the online system decreases bid amounts of ad requests if the determined metric for the identified third party system indicates greater interaction by users presented with advertisements via the online system than by users presented with advertisements via the identified third party system. Similarly, the online system increases bid amounts of ad requests if the determined metric for the identified third party system indicates reduced interaction by users presented with advertisements via the online system than by users presented with advertisements via the identified third party system. This allows the online system to modify bid amounts of ad requests to account for differences in interactions performed by users presented with advertisements via the online system or presented via the identified third party system, so an entity associated with an advertisement receives the same benefit relative to the amount the entity provides to the online system in exchange for presenting the advertisement when the advertisement is presented via the online system or via the identified third party system.

When the online system subsequently receives a request from the identified third party system for one or more advertisements, the online system retrieves the modified bid amounts for ad requests that are associated with the identified third party system and includes at least a set of ad requests in one or more selection processes using the modified bid amounts for ad requests in the set of ad requests. For example, the online system ranks ad requests in the set based at least in part on their modified bid amounts and selects advertisements from ad requests having at least a threshold position in the ranking for the identified third party system. The online system communicates the selected advertisements to the identified third party system 130 for presentation by the identified third party system.

In various embodiments, the online system stores the determined metric for the identified third party system in association with an identifier of the third party system. The online system may adjust the determined metric for the identified third party system over time. For example, the online system applies a decay factor to the determined metric for the identified third party system that attenuates the determined metric for the identified third party system as a length of time from when the metric for the identified third party system was determined increases. The online system alters the modified bid amounts of various ad requests based on the adjusted metric and may store the altered modified bid amounts in association with the ad requests and with the identified third party system. Attenuating the determined metric over time and altering the modified bid amounts as the determined metric is attenuated allows the online system to reduce the amount by which the bid amounts associated with various ad requests are modified as the determined metric for the identified third party system is reduced over time.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for modifying bid amounts for advertisement requests (“ad requests”) based on presentation of advertisements from the ad requests by different systems, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

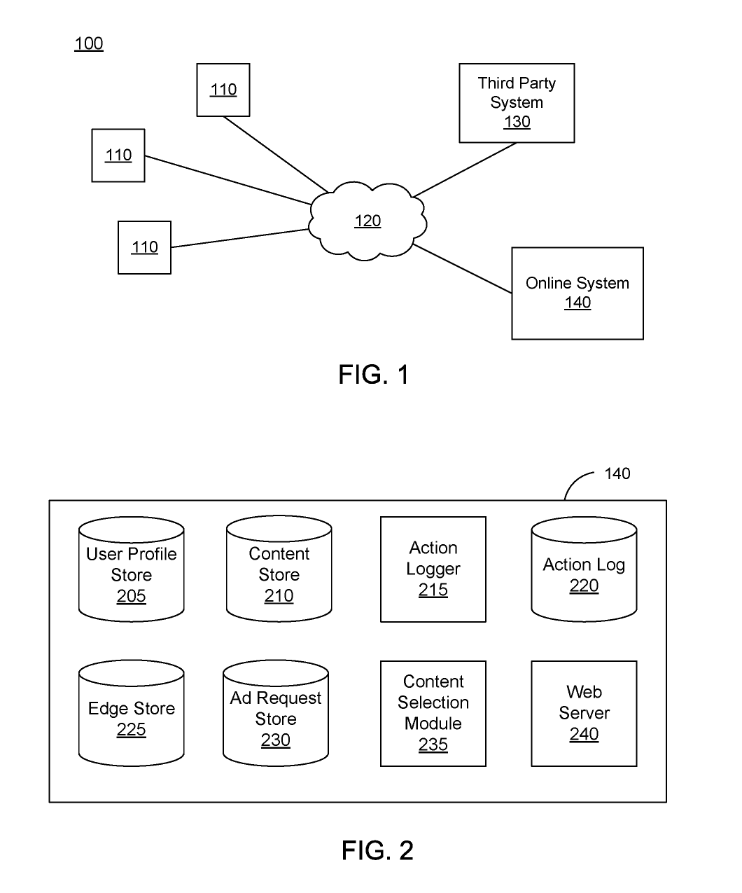

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, an advertisement request (“ad request”) store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content, also referred to as an “advertisement,” and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Various ad requests may include an objective identifying an interaction that an advertiser associated with an ad request desires users to perform when presented with an advertisements included in the ad request. Example objectives include: installing an application associated with an advertisement in an advertising campaign, indicating a preference for an advertisement included in the advertising campaign, sharing an advertisement included in the advertising campaign, interacting with an object associated with an advertisement in the advertising campaign, or performing any other suitable interaction. As an advertisement from an ad request is presented to online system users, the online system 140 logs interactions between users presented with the advertisement or with objects associated with the advertisement. Additionally, the online system 140 receives compensation from an entity associated with the ad request (e.g., an advertiser) as online system users perform interactions with advertisement that satisfy the objective included in the advertising request.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

The content selection module 235 selects one or more content items for communication to a client device 110 to be presented to a user. Content items eligible for presentation to the user are retrieved from the content store 210, from the ad request store 230, or from another source by the content selection module 235, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the user. For example, the content selection module 235 determines measures of relevance of various content items to the user based on characteristics associated with the user by the online system 140 and based on the user's affinity for different content items. Based on the measures of relevance, the content selection module 235 selects content items for presentation to the user. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items eligible for presentation to the user may include advertisements from ad requests or other content items associated with bid amounts. The content selection module 235 uses the bid amounts associated with ad requests when selecting content for presentation to the user. In various embodiments, the content selection module 235 determines an expected value associated with various ad requests (or other content items) based on their bid amounts and selects content items associated with a maximum expected value or associated with at least a threshold expected value for presentation. An expected value associated with an ad request or with a content item represents an expected amount of compensation to the online system 140 for presenting an ad request or a content item. For example, the expected value associated with an ad request is a product of the ad request's bid amount and a likelihood of the user interacting with the ad content from the ad request. The content selection module 235 may rank ad requests based on their associated bid amounts and select ad requests having at least a threshold position in the ranking for presentation to the user. In some embodiments, the content selection module 235 ranks both content items not associated with bid amounts and ad requests in a unified ranking based on bid amounts associated with ad requests and measures of relevance associated with content items and ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

For example, the content selection module 235 receives a request to present a feed of content to a user of the online system 140. The feed may include one or more advertisements as well as content items, such as stories describing actions associated with other online system users connected to the user. The content selection module 235 accesses one or more of the user profile store 205, the content store 210, the action log 220, and the edge store 225 to retrieve information about the user. For example, information describing actions associated with other users connected to the user or other data associated with users connected to the user are retrieved. Additionally, one or more advertisement requests (“ad requests”) may be retrieved from the ad request store 235. The retrieved stories, ad requests, or other content items, are analyzed by the content selection module 235 to identify candidate content items, including ad requests, eligible for presentation to the user. For example, content items associated with users who not connected to the user or stories associated with users for whom the user has less than a threshold affinity are discarded as candidate content items. Based on various criteria, the content selection module 235 selects one or more of the content items or ad requests identified as candidate content for presentation to the identified user. The selected content items or advertisements from selected ad requests are included in a feed of content that is presented to the user. For example, the feed of content includes at least a threshold number of content items describing actions associated with users connected to the user via the online system 140.

In various embodiments, the content selection module 235 presents content to a user through a newsfeed including a plurality of content items selected for presentation to the user. One or more advertisements may also be included in the feed. The content selection module 235 may also determine the order in which selected content items or advertisements are presented via the feed. For example, the content selection module 235 orders content items or advertisements in the feed based on likelihoods of the user interacting with various content items or advertisements.

The content selection module 235 selects content for presentation by one or more third party systems 130 in various embodiments. For example, the content selection module 235 receives requests from third party systems 130 for advertisements to be presented by the third party systems 130. When the content selection module 235 receives a request from a third party system 130 for an advertisement, the content selection module 235 selects one or more advertisements from ad requests in the ad request store 230 based on the bid amounts of the ad requests and communicates the selected one or more advertisements to the third party system 130 for presentation.

However, advertisements presented to users via the online system 140 (e.g., in a feed of content provided to users via the online system 140) may provide a different value to advertisers or other entities than advertisements presented to users via third party systems 130. For example, users more frequently interact with advertisements presented via the online system 140 than with advertisements presented by a third party system 130 or more frequently perform certain types of interactions when presented with advertisements via the online system 140 than when presented with advertisements via a third party system 130. To mitigate potential discrepancies in interactions performed by users presented with advertisements via the online system 140 or via a third party system 130, the content selection module 235 modifies bid amounts of ad requests based on differences in interactions performed by users presented with advertisements via the online system 140 and interactions performed by users presented with advertisements via a third party system 130. When the content selection module 235 receives a request for an advertisement from the third party system 130, the content selection module 235 identifies stored ad requests from the ad request store 230 in response to the received request and selects the advertisement from the stored ad requests based on the modified bid amounts associated with stored ad requests.

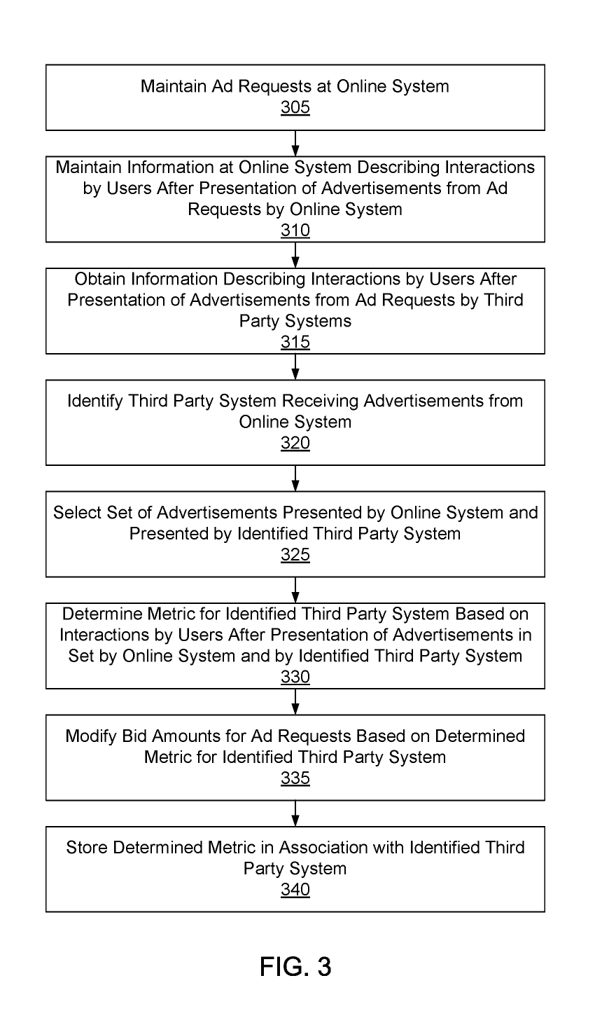

As further described below in conjunction with FIG. 3, the content selection module 235 retrieves information from the action log 220 describing interactions performed by users presented with advertisements selected by the online system 140 via the online system 140. For example, the content selection module 235 retrieves information from the action log 220 identifying certain interactions performed by users after presentation of an advertisement via the online system 140 (e.g., installation of an application associated with an advertisement presented by the online system, purchase of products or services within an application by users after presentation of an advertisement associated with the application by the online system 140, purchases of goods or services by users after presentation of an advertisement associated with the goods or services by the online system 140, accesses of content after presentation of an advertisement associated with the content to the users by the online system 140, selection of an advertisement presented by the online system, etc.). Additionally, the content selection module 235 obtains information from various third party systems 130 describing interactions performed by users after the third party systems 130 presented the users with one or more advertisements received from the content selection module 235. For example, the content selection module 235 retrieves the information describing user interactions after presentation of one or more advertisements from a third party system 130 or retrieves information describing user interactions performed after presentation of an advertisement associated with an identifier of the third party system 130 from the action log 220. Based on the information describing interactions performed by users after presentation of advertisements via the online system 140 and the information describing interactions performed by users after presentation of advertisements via third party systems 130, the content selection module 235 modifies bid amounts of various ad requests to account for different amounts of interaction performed by users after presentation of advertisements by the online system 140 and after presentation of advertisements by third party systems 130.

As further described below in conjunction with FIG. 3, to modify bid amounts of various ad requests, the content selection module 235 identifies a third party system 130 and selects a set of advertisements presented to users via the online system 140 and also presented to users via the identified third party system 130. In some embodiments, the content selection module 235 selects the set of advertisements so the set includes advertisements having one or more common characteristics that were presented to users by the online system 140 and presented to users by the identified third party system 130. Characteristics of an advertisement include: an entity associated with the advertisement (e.g., an advertiser), an objective included in an ad request including the advertisement (i.e., a desired interaction by a user after presentation of the advertisement specified by an entity associated with the ad request), a location in which the advertisement was presented relative to other content, or any other suitable information).

Based on the information describing interactions performed by users after presentation of one or more advertisements in the selected set to the users by the online system 140 and based on the information describing interactions performed by users after presentation of one or more advertisements in the selected set to the users by the identified third party system 130, the content selection module 235 determines a metric for the identified third party system 130. The content selection module 235 compares interactions performed by users after presentation of one or more advertisements in the selected set of advertisements to the users via the online system 140 to interactions performed by the users after presentation of one or more advertisements in the selected set to the users via the identified third party system 130 and determines the metric based on the comparison. For example, the content selection module 235 determines the metric based on a difference between a number of a certain type of interaction performed by users after the users were presented with advertisements from the selected set via the online system 140 and a number of the certain type of interaction performed by users after the users were presented with advertisements from the selected set via the identified third party system 130. Determination of the metric for the identified third party system 130 is further described below in conjunction with FIG. 3.

The content selection module 235 retrieves bid amounts for various ad requests from the ad request store 230 and modifies the bid amounts based on the determined metric for the identified third party system 130. In some embodiments, the content selection module 235 stores the determined metric for the identified third party system 130 in association with the identified third party system 130, allowing determination of modified bid amounts for advertisements in ad requests based on the determined metric. Alternatively, the content selection module 235 stores the modified bid amounts in the ad request store 230 in association with the identified third party system 130 and with the ad requests. In some embodiments, the content selection module 235 associates different adjustment values with different ranges of the metric and selects an adjustment value associated with a range that includes the determined metric for the identified third party system 130. The content selection module 235 then increases or decreases the bid amount of an ad request by the selected adjustment value to modify the bid amount for the ad request. When modifying bid amounts, the content selection module 235 decreases bid amounts of ad requests if the determined metric for the identified third party system 130 indicates greater interaction by users presented with advertisements via the online system 140 than by users presented with advertisements via the identified third party system 130. Similarly, the content selection module 235 increases bid amounts of ad requests if the determined metric for the identified third party system 130 indicates reduced interaction by users presented with advertisements via the online system 140 relative to interaction by users presented with advertisements via the identified third party system 130. This allows the modified bid amounts to account for differences in interactions performed by users presented with advertisements via the online system 140 or presented via the identified third party system 130, so an entity associated with an advertisement receives the same benefit relative to the amount the entity provides to the online system 140 in exchange for presenting the advertisement when the advertisement is presented via the online system 140 or via the identified third party system 130.

When the content selection module 235 subsequently receives a request from the identified third party system 130 for one or more advertisements, the content selection module 235 may retrieve the metric for the identified third party system and determine modified bit amounts for ad requests based on the metric and bid amounts included in the ad requests or retrieves modified bid amounts associated with the identified third party system 130 for ad requests and includes at least a set of the ad requests in one or more selection processes along with their modified bid amounts. For example, the content selection module 235 ranks ad requests in the set based at least in part on their modified bid amounts or based at least in part on expected values determined using the modified bid amounts. The content selection module 235 selects advertisements from ad requests having at least a threshold position in the ranking or having at least a threshold modified bid amounts and communicates the selected advertisements to the identified third party system 130 for presentation.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

### Modifying Bid Amounts of Ad Requests for Presentation by Different Systems

FIG. 3 is a flowchart of one embodiment of a method for modifying bid amounts for advertisement requests (“ad requests”) based on presentation of advertisements from the ad requests by different systems. In some embodiments, the method may include different and or additional steps than those described in conjunction with FIG. 3. Additionally, in various embodiments, steps of the method may be performed in different orders than the order described in conjunction with FIG. 3.

An online system 140 maintains 305 multiple advertisement requests (“ad requests”). In some embodiments, the online system 140 locally stores ad requests. Alternatively, the online system 140 retrieves ad requests from one or more third party systems 130 or other sources. In other embodiments, the online system 140 locally stores a set of ad requests and obtains additional ad requests from one or more third party systems 130. As described above in conjunction with FIG. 2, an ad request includes an advertisement and a bid amount specifying an amount of compensation received by the online system 140 from an entity associated with the ad request in exchange for presenting the advertisement in the ad request to one or more users. The online system 140 presents advertisements from ad requests to users via the online system 140 and also communicates advertisements from ad requests to one or more third party systems 130 for presentation by the third party system 130. For example, the online system 140 receives a request from a third party system 130 for an advertisement, selects an advertisement from the ad requests maintained 305 by the online system 140, and communicates the selected advertisement to the third party system 130 for presentation by the third party system 130.

As the online system 140 presents advertisements from ad requests maintained by the online system 140 to its users, the online system 140 maintains 310 information describing interactions performed by users after the users were presented with the advertisements. In various embodiments, the online system 140 stores information identifying an ad request including an advertisement presented to a user by the online system 140 (e.g., an identifier associated with the ad request), a description of an action performed by the user, and a time when the user performed the action. The online system 140 may also store information identifying the user presented with the advertisement who performed the action in some embodiments. In some embodiments, the online system 140 maintains 310 information describing certain types of actions performed by users after the users were presented with an advertisement from an ad request maintained 305 by the online system 140. For example, the online system 140 maintains information identifying installation of applications associated with an advertisement by users who were presented with the advertisement via the online system 140, such as an indication the user installed the application and a time when the user installed the application. Identifying installation of an application by a user after presentation of an advertisement associated with the application is further described in U.S. patent application Ser. No. 14/334,651, filed on Jul. 17, 2014, which is hereby incorporated by reference in its entirety. In other embodiments, the online system 140 maintains 310 information identifying purchases of products or services within an application by users after presentation of an application associated with the application to the users.

Other information describing interactions performed by users who were presented with advertisements via the online system may be maintained 310 by the online system 140. For example, the online system 140 maintains 310 identifying purchases of goods or services by users after presentation of an advertisement to the users by the online system 140, accesses of content (e.g., websites, web pages) by users after presentation of an advertisement associated with the content to the users by the online system 140, selection of an advertisement presented to the user by the online system 140, or any other suitable interaction by users after presentation of an advertisement to the users by the online system 140. Information maintained 310 by the online system 140 identifies an advertisement presented to a user and a type of action (e.g., a purchase, an application installation, selection of the advertisement, etc.) performed by the user; information identifying the user and a time when the user performed the action may also be maintained 310 in association with the information identifying the advertisement. In some embodiments, the information maintained 310 by the online system 140 identifies interactions performed by the user within a threshold time of a time when the online system 140 presented the advertisement to the user.

Additionally, the online system 140 provides advertisements from ad requests maintained by the online system 140 to various third party systems 130 for presentation by the third party systems 130. Different third party system 130 may maintain information describing interactions performed by users after presentation of an advertisement from the online system 140 to the users by the third party system 130. For example, a third party system 130 maintains similar information as the information maintained 310 by the online system 140 further described above, describing interactions performed by users after the third party system 130 presents an advertisement from the online system 140 to the users. In some embodiments, a third party system 130 communicates information to the online system 140 describing interactions by users after presentation of an advertisement to the users by the third party system 130, and the online system 140 maintains information describing interactions performed by users after presentation of one or more advertisements to the users by the third party system 130. For example, a third party system 130 communicates an identifier of the third party system 130, an identifier of an advertisement presented to a user by the third party system 130, and a type of action performed by the user to whom the advertisement was presented; in some embodiments, the third party system 130 communicates a time when the action was performed and information identifying the user who performed the action to the online system 140, which stores the information describing interaction by the user after presentation of the advertisement to the user in association with the identifier of the third party system 130. This allows the online system 140 to locally maintain information describing interactions by users after presentation of advertisements to the users by a third party system 130.

As presentation of advertisements on different third party systems 130 or on the online system 140 may provide an entity associated with the advertisement with different value from advertisement presentation, the online system 140 modifies bid amounts associated with various ad requests to offset discrepancies in value from presenting advertisements via third party systems 130 relative to presenting advertisements via the online system 140. For example, presentation of an advertisement via a third party system 130 causes fewer users to perform a type of interaction (e.g., install an application) than presentation of the advertisement via the online system 140. To modify bid amounts associated with ad requests, the online system 140 obtains 315 information describing interactions performed by users after presentation of advertisements from ad requests maintained 305 by the online system 140 to users via one or more third party systems 130. In some embodiments, the online system 140 obtains 315 the information by requesting information describing interactions by users with advertisements presented by one or more third party systems 130 from the third party systems 130. Alternatively, the online system 140 retrieves information stored by the online system 140 describing interactions performed by users after presentation of advertisements from ad requests maintained 305 by the online system 140 via one or more third party systems 130. In other embodiments, the online system 140 requests information describing interactions performed by users after presentation of advertisements received from the online system 140 by third party systems 130 from a set of third party systems 130 and retrieves information stored by the online system 140 describing interactions performed by users after presentation of advertisements maintained by the online system 140 by another set of third party systems 130.

The online system 140 identifies 320 a third party system 130 that received one or more advertisements from the online system 140 and selects 325 a set of advertisements from ad requests maintained 305 by the online system 140 that were presented to users by the online system 140 and that were presented to users by the identified third party system 130. For example, the online system 140 identifies 320 a third party system 130 and selects 325 advertisements associated with information indicating the online system 140 presented the advertisements and associated with information indicating the online system 140 provided the advertisements to the identified third party system 130, or associated with information indicating the identified third party system 130 presented the advertisements to one or more users. In some embodiments, the online system 140 receives an indication that a third party system 130 that received an advertisement from an ad request maintained 305 by the online system 140 presented the advertisements. Alternatively, the online system 140 provides an advertisement to a third party system 130 when the third party system 130 requests an advertisement for presentation by the third party system 130 and stores an indication that the advertisement was provided to the third party system 130 in association with an identifier of the third party system 130. Hence, the online system 140 selects 325 advertisements associated with information indicating they were communicated to or presented by an identifier corresponding to the identified third party system 130 and associated with information that the advertisements were presented by the online system 140.

In some embodiments, the online system 140 selects 325 the set of advertisements so the set includes advertisements having one or more common characteristics and that were presented to users by the online system 140 as well as presented to users by the identified third party system 130. Characteristics of an advertisement include: an entity associated with the advertisement (e.g., an advertiser), an objective included in an ad request including the advertisement, a location in which the advertisement was presented relative to other content (e.g., as a banner advertisement, in line with other content, within an application, etc.), or any other suitable information). For example, the online system 140 selects 325 the set of advertisements to include advertisements presented in a similar location relative to other content by the identified third party system 130 and by the online system 140 (e.g., the set includes banner advertisements presented to users by the online system 140 as well as presented to users by the identified third party system 130). As another example, the online system 140 selects 325 the set of advertisements to include advertisements associated with a specific entity (e.g., a specific advertiser) that were presented to users by the online system 140 as well as presented to users by the identified third party system 130. In other examples, the online system 140 selects 325 advertisements included in ad requests having a common objective or having one or more common targeting criteria that were presented to users by the online system 140 as well as presented to users by the identified third party system 130. In other examples, the online system 140 selects 325 advertisements placed in specific locations by the identified third party system 130 and by the online system 140 (e.g., placed in a specified coordinate location relative to other content presented to a user) or selects 325 advertisements having a common size when presented by the identified third party system 130 and by the online system 140.

Based on the information maintained 310 by the online system 140 describing interactions performed by users after presentation of one or more advertisements in the selected set to the users by the online system 140 and based on the information obtained 315 by the online system 140 describing interactions performed by users after presentation of one or more advertisements in the selected set to the users by the identified third party system 130, the online system 140 determines 330 a metric for the identified third party system 130. In some embodiments, if the number of interactions performed by users after presentation of one or more advertisements via the identified third party system 130 is less than a threshold value, the online system 140 may select an alternative value and determine 330 the metric based on a difference between the number of interactions performed by users after presentation of one or more advertisements in the selected set via the online system 140 and the alternative value. For example, the online system 140 selects an alternative value of an average number of interactions (or of a certain type of interaction) performed by users after presentation of one or more advertisements in the selected set (or one or more advertisements having at least a threshold number or a threshold percentage of characteristics matching characteristics of advertisements in the selected set) via other third party systems 130 (e.g., third party systems 130 with at least a threshold number or a threshold percentage of characteristics matching characteristics of the identified third party system 130, all third party systems).

The online system 140 compares interactions performed by users after presentation of one or more advertisements in the selected set of advertisements to the users via the online system 140 to interactions performed by the users after presentation of one or more advertisements in the selected set to the users via the identified third party system and determines 330 the metric based on the comparison. For example, the online system 140 determines 330 the metric based on a difference between a number of a certain type of interaction performed by users after the users were presented with advertisements from the selected set via the online system 140 and a number of the certain type of interaction performed by users after the users were presented with advertisements from the selected set via the identified third party system 130. As an example, the online system 140 determines 330 the metric based on a difference between a number of installations of applications associated with advertisements in the selected set by users after presentation of advertisements in the selected set by the online system 140 and a number of installations of applications associated with advertisements in the selected set by users after presentation of advertisements in the selected set by the identified third party system 130. In some embodiments, the metric for the identified third party system 130 is a ratio of the difference between the number of the certain type of interaction performed by users after the users were presented with advertisements from the selected set via the online system 140 and the number of the certain type of interaction performed by users after the users were presented with advertisements from the selected set via the identified third party system 130 to the number of the certain type of interaction performed by users after the users were presented with advertisements form the set via the online system 140.

As another example, the online system 140 determines 330 the metric for the identified third party system 130 by determining amounts of time users presented with advertisements from the selected set via the online system 140 interact with content associated with one or more advertisements in the set from information maintained by the online system 140 describing interactions performed by users and determining alternative amounts of time users presented with advertisements form the selected set via the identified third party system 130 interact with content associated with one or more advertisements in the set based on information obtained by the online system 140 from the identified third party system 130. The online system 140 determines 330 the metric for the identified third party system 130 based on one or more differences between the amounts of time and the alternative amounts of time. For example, the online system 140 determines an average of the amounts of time and an additional average of the alternative amounts of time and determines 330 the metric from a difference between the average of the amounts of time and the additional average of the alternative amounts of time (e.g., the metric is determined 330 as a percent difference between the average of the amounts of time and the additional average of the alternative amounts of time).

In another example, the online system 140 determines 330 the metric for the identified third party system based on returns on investment for advertisements in the set presented to users via the online system 140 and returns on investment for advertisements in the set presented to users via the identified third party system 130. For example, the online system 140 determines an amount an entity associated with an advertisement in the set has provided to the online system 140 in exchange for presentation of the advertisement and obtains an amount of profit by the entity from presentation of the advertisement via the online system 140. The online system 140 then determines a return on investment (ROI) of the advertisement as a ratio of a difference between the amount of profit by the entity from presentation of the advertisement via the online system 140 and the amount the entity associated with the advertisement has provided to the online system 140 to the amount the entity associated with the advertisement has provided to the online system 140. Similarly, the online system 140 determines an additional ROI of the advertisement based on the amount the entity associated with the advertisement in the set has provided to the online system in exchange for presentation of the advertisement and an amount of profit by the entity from presentation of the advertisement via the identified third party system 130. In some embodiments, the online system 140 determines an average ROI from presenting advertisements in the set via the online system 140 and an additional average ROI from presenting advertisements in the set via the identified third party system 130 and determines 330 the metric for the identified third party system 130 based on a difference between the average ROI and the additional ROI. For example, the metric for the identified third party system 130 is a ratio of a difference between the average ROI and the additional average ROI to the average ROI.

As another example, the online system 140 determines 330 the metric for the identified third party system 130 based on a difference between usage of an application associated with advertisements in the selected set by users after presentation of advertisements in the selected set by the online system 140 and usage of the application associated with advertisements in the selected set after presentation of advertisements in the selected set by the identified third party system 130. In some embodiments, the application includes instructions that, when executed by a client device 110 on which the application is executed, communicate information to the online system 140 or to the identified third party system 130 identifying an amount of time the application has been executed on the client device 110 or identify one or more interactions with the application received by the client device 110. Information identifying the client device 110 executing the application or identifying a user associated with the client device 110 executing the application may be communicated to the online system 140 or to the identified third party system 130 along with the information describing usage of the application. Based on a time when an advertisement from the selected set associated with the application was presented to users via the online system 140 or via the identified third party system 130, the online system 140 identifies usage of the application by users after presentation of the advertisement by the online system 140 and after presentation of the advertisement by the identified third party system 130 and determines 330 the metric based on a difference between an amount of usage of the application by users presented with the advertisement via the online system 140 and an amount of usage of the application presented with the advertisement via the identified third party system 130.

In other embodiments, the online system 140 determines 330 the metric based on a difference between a number of a certain type of interaction performed by users after the users were presented with advertisements from the selected set via the online system 140 and a number of the certain type of interaction performed by users after the users were presented with advertisements from the selected set via the identified third party system 130. For example, the online system 140 determines a percentage of a certain type of interaction (e.g., clicking on a presented advertisement from the selected set) performed by users relative to other interactions performed by the users after presentation of advertisements from the selected set to the users via the online system 140 and determines an additional percentage of the certain type of interaction performed by users relative to other interactions performed by the users after presentation of advertisements from the selected set to the users via the identified third party system 130. The online system 140 determines 330 the metric based on a difference between the percentage and the additional percentage, allowing the metric to reflect a change in a certain type of user interaction relative to other user interactions after presentation of advertisements by the online system 140 or by the identified third party system 130. In other embodiments, the online system 140 applies one or more machine learned models to data describing interactions by users presented with advertisements from the selected set via the online system 140 and data describing interactions by users presented with advertisement from the selected set via the identified third party system 130 to determine 330 the metric for the identified third party system 130. For example, a machine learned model determines scores for users presented with advertisements from the selected set via the online system 140 and for users presented with advertisements from the selected set via the identified third party system 130, the machine learned model (or another machine learned model) determines 330 the metric for the identified third party system 130 based on a difference between the determined scores.

In some embodiments, the metric for the identified third party system 130 is based at least in part a type of the identified third party system 130. For example, a type of a third party system 130 is based on subject matter presented by the third party system 130. As an example, a third party system 130 has a different type depending on whether the third party system 130 presents news content, sports content, entertainment content, social content, or other types of content. In some embodiments, the determined metric for the identified third party system 130 is increased if the identified third party system 130 has a type satisfying one or more criteria or is decreased if the identified third party system has a type satisfying one or more alternative criteria. Alternatively, different methods may be used to determine 330 the metric for the identified third party system 130 based on a type of the identified third party system 130; for example, different types of third party systems 130 are associated with different ranges of differences between interactions by users after presentation of advertisements in the set via the online system 140 and interactions by users after presentation of advertisements in the set via the third party system 130 corresponding to values of the metric. For example, the online system 140 determines a type of the identified third party system 130 based on information maintained by the online system 140, retrieves ranges of differences between interactions by users after presentation of advertisements in the set via the online system 140 and interactions by users after presentation of advertisements in the set via the third party system 130 associated with the determined type, and determines 330 the metric for the identified third party system 130 based on a range including a difference between interactions by users after presentation of advertisements in the set via the online system 140 and interactions by users after presentation of advertisements in the set via the third party system 130.

Based on the determined metric for the identified third party system 130, the online system 140 modifies 335 bid amounts for various ad requests maintained by the online system 140 and stores 340 the determined metric for the identified third party system 130 in association with the identified third party system 130. In some embodiments, the online system 140 associates different adjustment values with different ranges of the metric and selects an adjustment value associated with a range that includes the determined metric for the identified third party system 130; the online system 140 increases or decreases the bid amount of an ad request by the selected adjustment value to modify 335 the bid amount for the ad request. Alternatively, the online system 140 increases or decreases a bid amount of an ad request by a percentage (or an amount) generated from the determined metric or by the determined metric. When modifying 335 bid amounts, the online system 140 decreases bid amounts of ad requests if the determined metric for the identified third party system 130 indicates greater interaction by users presented with advertisements via the online system 140 than by users presented with advertisements via the identified third party system 130. Similarly, the online system 140 increases bid amounts of ad requests if the determined metric for the identified third party system 130 indicates reduced interaction by users presented with advertisements via the online system 140 than by users presented with advertisements via the identified third party system 130. This allows the online system 140 to modify 335 bid amounts of ad requests to account for differences in interactions performed by users presented with advertisements via the online system 140 or presented via the identified third party system 130, so an entity associated with an advertisement receives the same benefit relative to the amount the entity provides to the online system 140 in exchange for presenting the advertisement 140 when the advertisement is presented via the online system 140 or via the identified third party system 130. In some embodiments, the online system 140 stores the modified bid amounts in association with the ad requests and with the identified third party system 130.

Hence, the online system 140 stores 340 the metric determined 330 for the identified third party system 130 in association with the identified third party system 130, allowing modification of bid amounts of ad requests based on the determined metrics 330, and may store the modified bid amounts in some embodiments. For example, the online system 140 stores 340 the determined metric in association with an identifier of the identified third party system 130. When the online system 140 subsequently receives a request from the identified third party system 130 for one or more advertisements, the online system 140 retrieves the determined metric associated with the identified third party system modifies 335 bid amounts included in various ad requests based on the determined metric, as further described above, and includes at least a set of ad requests in one or more selection processes using the modified bid amounts for ad requests in the set of ad requests. For example, the online system 140 ranks ad requests in the set based at least in part on their modified bid amounts and selects advertisements from ad requests having at least a threshold position in the ranking for the identified third party system 130, as further described above in conjunction with FIG. 2. The online system 140 communicates the selected advertisements to the identified third party system 130 for presentation by the identified third party system 130. Alternatively, the online system 140 stores modified bid amounts for various ad requests in association with the identified third party system 130 and with identifiers corresponding to the various ad requests. When the online system 140 receives a request from the identified third party system 130 for one or more advertisements, the online system 140 retrieves the modified bid amounts for ad requests associated with the identified third party system 130 and includes at least a set of the ad requests in one or more selection processes using the modified bid amounts for ad requests in the set of ad requests.

In various embodiments, the online system 140 stores the determined metric for the identified third party system 130 in association with an identifier of the third party system 130. The online system 140 may adjust the determined metric for the identified third party system 130 over time. For example, the online system 140 applies a decay factor to the determined metric for the identified third party system 130 that attenuates the determined metric for the identified third party system 130 as a length of time from when the metric for the identified third party system 130 was determined increases. The online system 140 alters the modified bid amounts of various ad requests based on the adjusted metric and may store the altered modified bid amounts in association with the ad requests and with the identified third party system 130. Attenuating the determined metric over time and altering the modified bid amounts as the determined metric is attenuated allows the online system 140 to reduce the amount by which the bid amounts associated with various ad requests are modified 335 as the determined metric for the identified third party system 130 is reduced over time.

Additionally, the online system 140 provides information to the identified third party system 130 based on the determined metric for the third party system 130. In various embodiments, the online system 140 determines metrics for multiple third party systems 130 as described above and stores metrics in association with the third party systems 130. Based on metrics determined for different third party systems 130, the online system 140 may provide information to the identified third party system 130 describing the metric for the identified third party system 130 relative to metrics determined for other third party systems 130. For example, the online system 140 ranks various third party systems 130 based on their metrics, determines a position in the ranking of the identified third party system 130 and communicates the position in the ranking to the identified third party system 130. For example, the online system 140 communicates a percentile or a quintile score to the identified third party system 130 specifying a percentile or a quintile of metrics for third party systems 130 including the metric for the identified third party system 130. In some embodiments, the online system 140 ranks third party systems 130 having one or more common characteristics (e.g., a common type, a common geographic location, an association with a common entity, etc.) based on their metrics and provides information to the identified third party system 130 specifying a position of the identified third party system 130 in the ranking of third party systems 130 having the one or more common characteristics.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
maintaining a plurality of advertisement requests (“ad requests”) at an online system, each ad request including an advertisement and a bid amount specifying an amount of compensation received by the online system for presenting the advertisement;
maintaining information at the online system describing interactions performed by users after presentation of advertisements from one or more of the plurality of ad requests via the online system;
obtaining information at the online system describing interactions performed by users after presentation of advertisements from one or more of the plurality of ad requests via one or more third party systems that received the advertisements;
identifying a third party system that receives advertisements from the online system;
selecting a set of advertisements presented by the online system and presented by the identified third party system;
determining a metric for the identified third party system based at least in part on a comparison of interactions performed by users after presentation of one or more advertisements in the set of advertisements to the users via the online system to interactions performed by the users after presentation of one or more advertisements in the set of advertisements to the users via the identified third party system; and
modifying bid amounts for the plurality of ad requests based at least in part on the determined metric.

2. The method of claim 1, further comprising:
receiving a request for one or more advertisements from the identified third party system; and
selecting one or more advertisements for the identified third party system from the plurality of ad requests based at least in part on the modified bid amounts.

3. The method of claim 1, wherein determining the metric for the identified third party system comprises:
determining a number of installations of applications associated with one or more advertisements in the set after presentation of the one or more advertisements in the set to the users by the online system from the maintained information;
determining an additional number of installations of applications associated with one or more advertisements in the set after presentation of the one or more advertisements in the set to the users by the identified third party system from the obtained information; and
determining the metric based at least in part on a difference between the determined number of installations and the determined additional number of installations.

4. The method of claim 1, wherein determining the metric for the identified third party system comprises:
determining amounts of time users interact with content associated with one or more advertisements in the set after presentation of the one or more advertisements in the set to the users by the online system from the maintained information;
determining alternative amounts of time users interact with content associated with one or more advertisements in the set after presentation of the one or more advertisements in the set to the users by the identified third party system from the obtained information; and
determining the metric based at least in part on a difference between the determined amounts of time and the determined alternative amounts of time.

5. The method of claim 1, wherein the metric is further determined based at least in part on a type associated with the identified third party system.

6. The method of claim 1, wherein selecting the set of advertisements presented by the online system and presented by the identified third party system comprises:
selecting a set of advertisements having a common characteristic that were presented by the online system and that were presented by the identified third party system.

7. The method of claim 6, wherein the common characteristic comprises a placement of an advertisement when presented relative to other content presented in conjunction with the advertisement.

8. The method of claim 6, wherein the common characteristic comprises an entity associated with an advertisement.

9. The method of claim 6, wherein the common characteristic comprises an objective included in an ad request including an advertisement.

10. The method of claim 1, further comprising:
adjusting the metric based on application of a decay factor to the metric, the decay factor attenuating the metric over time; and
altering the modified bid amounts for the plurality of ad requests based on the adjusted metric.

11. A computer program product comprising a computer-readable storage medium having instructions encoded thereon that, when executed by a processor, cause the processor to:
maintain a plurality of advertisement requests (“ad requests”) at an online system, each ad request including an advertisement and a bid amount specifying an amount of compensation received by the online system for presenting the advertisement;
maintain information at the online system describing interactions performed by users after presentation of advertisements from one or more of the plurality of ad requests via the online system;
obtain information at the online system describing interactions performed by users after presentation of advertisements from one or more of the plurality of ad requests via one or more third party systems that received the advertisements;
identify a third party system that receives advertisements from the online system;
select a set of advertisements presented by the online system and presented by the identified third party system;
determine a metric for the identified third party system based at least in part on a comparison of interactions performed by users after presentation of one or more advertisements in the set of advertisements to the users via the online system to interactions performed by the users after presentation of one or more advertisements in the set of advertisements to the users via the identified third party system; and
modify bid amounts for the plurality of ad requests based at least in part on the determined metric.

12. The computer program product of claim 11, wherein the computer-readable storage medium further has instructions encoded thereon that, when executed by the processor, cause the processor to:
receive a request for one or more advertisements from the identified third party system; and
select one or more advertisements for the identified third party system from the plurality of ad requests based at least in part on the modified bid amounts.

13. The computer program product of claim 11, wherein determine the metric for the identified third party system comprises:
determine a number of installations of applications associated with one or more advertisements in the set after presentation of the one or more advertisements in the set to the users by the online system from the maintained information;
determine an additional number of installations of applications associated with one or more advertisements in the set after presentation of the one or more advertisements in the set to the users by the identified third party system from the obtained information; and
determine the metric based at least in part on a difference between the determined number of installations and the determined additional number of installations.

14. The computer program product of claim 11, wherein determine the metric for the identified third party system comprises:
determine amounts of time users interact with content associated with one or more advertisements in the set after presentation of the one or more advertisements in the set to the users by the online system from the maintained information;
determine alternative amounts of time users interact with content associated with one or more advertisements in the set after presentation of the one or more advertisements in the set to the users by the identified third party system from the obtained information; and
determine the metric based at least in part on a difference between the determined amounts of time and the determined alternative amounts of time.

15. The computer program product of claim 11, wherein the metric is further determined based at least in part on a type associated with the identified third party system.

16. The computer program product of claim 11, wherein select the set of advertisements presented by the online system and presented by the identified third party system comprises:
select a set of advertisements having a common characteristic that were presented by the online system and that were presented by the identified third party system.

17. The computer program product of claim 16, wherein the common characteristic comprises a placement of an advertisement when presented relative to other content presented in conjunction with the advertisement.

18. The computer program product of claim 16, wherein the common characteristic comprises an entity associated with an advertisement.

19. The computer program product of claim 16, wherein the common characteristic comprises an objective included in an ad request including an advertisement.

20. The computer program product of claim 11, wherein the computer-readable storage medium further has instructions encoded thereon that, when executed by the processor, cause the processor to:
adjust the metric based on application of a decay factor to the metric, the decay factor attenuating the metric over time; and
altering the modified bid amounts for the plurality of ad requests based on the adjusted metric.
